(19) United States
(12) Patent Application Publication
(10) Pub. No.: US 2023/0253919 A1
(43) Pub. Date: Aug. 10, 2023

(54) METHOD FOR IDENTIFYING PARAMETERS OF SINGLE-DIODE PHOTOVOLTAIC CELLS

(71) Applicant: Wenzhou University, Zhejiang (CN)

(72) Inventors: Pengjun WANG, Zhejiang (CN); Wei ZHOU, Zhejiang (CN); Huiling CHEN, Zhejiang (CN); Bo CHEN, Zhejiang (CN); Yijian SHI, Zhejiang (CN)

(73) Assignee: Wenzhou University, Zhejiang (CN)

(21) Appl. No.: 18/008,671

(22) PCT Filed: Jan. 29, 2021
(86) PCT No.: PCT/CN2021/074359

§ 371 Date: Dec. 7, 2022

(30) Foreign Application Priority Data
Nov. 20, 2020 (CN) 202011312725.6

(51) Int. Cl. H02S 50/10

(52) U.S. Cl. CPC H02S 50/10

(57) ABSTRACT

A method for identifying parameters of single-diode photovoltaic cells comprises: measuring an actual output voltage and an actual output current of a single-diode photovoltaic cell under a given temperature and a given light intensity; constructing an ideal model of the single-diode photovoltaic cell, determining to-be-identified parameters, and establishing an objective function; and identifying the to-be-identified parameters through a backtracking search algorithm based on a sine-cosine mechanism to obtain to-be-identified parameter data of the single-diode photovoltaic cell, so that parameters identification of the single-diode photovoltaic cell is completed. The method adopts the backtracking search algorithm for parameter identification and replaces a mutation operation of the backtracking search algorithm with the sine-cosine mechanism during the identification process to prevent part of optimal search spaces from being neglected, thus being able to identify the parameters of single-diode photovoltaic cells more reliably and accurately.

### TECHNICAL FIELD

The invention relates to a method for identifying parameters of photovoltaic cells, in particular to a method for identifying parameters of single-diode photovoltaic cells.

### DESCRIPTION OF RELATED ART

With the development of modern industry and economy, solar energy is considered as an effective solution to a series of problems because it is inexhaustible and free of geographic restrictions and pollution. Photovoltaic cells can directly convert solar energy into electric energy and are an important constituent part of a photovoltaic power generation system. The parameters of the photovoltaic cells may be influenced by environmental and other factors, so accurate identification of the parameters of the photovoltaic cells can lay a basis for studying and diagnosing faults of the photovoltaic cells and has practical significance in improving the efficiency of the photovoltaic power generation system.

Common photovoltaic cells mainly include single-diode photovoltaic cells and double-diode photovoltaic cells. Wherein, compared with the double-diode photovoltaic cells, the single-diode photovoltaic cells are simple in structure and calculation and have non-linear output characteristics that can be accurately described, thus having been widely applied to practical engineering.

At present, the parameters of the photovoltaic cells are identified mainly through an analysis method, a numerical computing method and an optimization algorithm-based estimation method. The analysis method can resolve a solution rapidly, but it may reduce the accuracy of the solution due to approximate processing and has low parameter identification precision. The numerical computing method obtains a solution by randomly selecting an initial value and observing the convergence of the initial value, so the accuracy of the solution depends on the selected initial value and decreases with the increase of identified parameters, and the parameter identification precision is also low. The optimization algorithm-based estimation method is a novel method for identifying the parameters of photovoltaic cells developed in recent years, and has the advantages of being simple in operation, few in restriction, high in robustness and suitable for resolving solutions of various complicated problems, thus having gradually replaced the analysis method and the numerical computing method to be widely used for identifying the parameters of photovoltaic cells. However, most optimization algorithms used in the optimization algorithm-based estimation method have the defects of low convergence rate and local optimum. The backtracking search algorithm, as one optimization algorithm-based estimation method, is a main method for identifying the parameters of single-diode photovoltaic cells at present and obtains an optimal solution through operations such as initialization, selection-I, mutation, crossover and selection-II. However, when the backtracking search algorithm performs the mutation operation, part of optimal search spaces may be neglected, which will lead to unsatisfying identification precision of the parameters of the single-diode photovoltaic cells.

### SUMMARY

The technical issue to be settled by the invention is to provide a method for identifying parameters of single-diode photovoltaic cells, which adopts a backtracking search algorithm for parameter identification and replaces a mutation operation of the backtracking search algorithm with a sine-cosine mechanism during the identification process to prevent part of optimal search spaces from being neglected, thus being able to identify the parameters of single-diode photovoltaic cells more reliably and accurately.

The technical solution adopted by the invention to settle the above technical issue is as follows: a method for identifying parameters of single-diode photovoltaic cells comprises the following steps:

S1, measuring an actual output voltage and an actual output current of a single-diode photovoltaic cell under a given temperature and a given light intensity;

S2, constructing an ideal model of the single-diode photovoltaic cell, determining to-be-identified parameters, and establishing an objective function; and

S3, identifying the to-be-identified parameters, determined in S2, through a backtracking search algorithm based on a sine-cosine mechanism to obtain to-be-identified parameter data of the single-diode photovoltaic cell, so that identification of the parameters of the single-diode photovoltaic cell is completed.

A specific process of constructing an ideal model of the single-diode photovoltaic cell, determining to-be-identified parameters and establishing an objective function in S2 comprises:

S2.1, constructing the ideal model of the single-diode photovoltaic cell, wherein the ideal model of the single-diode photovoltaic cell is composed of a series resistor, a shunt resistor, a diode and an optical-drive current source; a positive pole of the optical-drive current source, an anode of the diode and one terminal of the series resistor are connected to one terminal of the shunt resistor; a negative pole of the optical-drive current source and a cathode of the diode are connected to the other terminal of the shunt resistor, and a connecting terminal is a negative pole of the single-diode photovoltaic cell; the other terminal of the series resistor is a positive pole of the single-diode photovoltaic cell;

S2.2, marking a resistance of the series resistor as Rₛ, marking a resistance of the shunt resistor as Rₛₕ, marking a forward current across the diode as I_{d}, marking an output current of the optical-drive current source as Iₚₕ, and expressing a characteristic equation of an output current and an output voltage of the single-diode photovoltaic cell by formula (1):

$${I}_{L} = {I}_{p h} - {I}_{d} - {I}_{s h} = {I}_{p h} - {I}_{sd} [ exp ( \frac{q ( {V}_{A} + {R}_{S} {I}_{A} )}{nkT} ) - 1 ] - \frac{{V}_{L} + {R}_{S} {I}_{L}}{{R}_{s h}} \qquad ( 1 )$$

Wherein, I_{L} represents a theoretical output current of the single-diode photovoltaic cell; V_{L} represents a theoretical output voltage of the single-diode photovoltaic cell; I_{sd} represents a reverse saturation current of the diode; q represents an electron charge (1.608×10⁻¹⁹C); k represents a Boltzmann constant (1.1.280×10⁻²³ J/K); T represents an absolute temperature of the single-diode photovoltaic cell; n represents a quality factor of the diode; exp represents an exponential function with e as a base; and five to-be-identified parameters of the single-diode photovoltaic cell are the output current Iₚₕ of the optical-drive current source, the reverse saturation current I_{sd} of the diode, the quality factor n of the diode, the resistance R_{S} of the series resistor and the resistance Rₛₕ of the shunt resistor, respectively;

S2.3, establishing the objective function of the single-diode photovoltaic cell, and expressing the objective function by formula (2):

$$f ( {V}_{A} , {I}_{A} , X ) = {I}_{p h} - {I}_{sd} [ exp ( \frac{q ( {V}_{A} + {R}_{S} {I}_{A} )}{nkT} ) - 1 ] - \frac{{V}_{A} + {R}_{S} {I}_{A}}{{R}_{s h}} - {I}_{A} \qquad ( 2 )$$

Wherein, I_{A} represents the actual output current of the single-diode photovoltaic cell; V_{A} represents the actual output voltage of the single-diode photovoltaic cell; q represents the electron charge (1.608×10⁻¹⁹C); k represents the Boltzmann constant (1.1.280×10⁻²³ J/K); T represents the absolute temperature of the single-diode photovoltaic cell; ranges of the five to-be-identified parameters are 0≤Iₚₕ≤1 A , 0≤I_{sd}≤1 μA , 0≤R_{S}≤0.5 Ω, 0≤Rₛₕ≤100 Ω and 1≤n≤2, respectively; ƒ(V_{A}, I_{A}, X) represents an error function of the theoretical output current and the actual output current of the single-diode photovoltaic cell; X represents a set of the to-be-identified parameters of the single-diode photovoltaic cell; in this method, by constructing the ideal model of the single-diode photovoltaic cell, the difficulty in identifying the parameters of the single-diode photovoltaic cell is greatly lowered without causing a great deviation; the objective function is established to obtain parameter identification results, which can further guide and correct the actual structure of the ideal model of the single-diode photovoltaic cell;

A specific process of identifying the to-be-identified parameters, determined in S2, through a backtracking search algorithm based on a sine-cosine mechanism to obtain to-be-identified parameter data of the single-diode photovoltaic cell in S3 comprises:

S3.1, marking a population size of the backtracking search algorithm based on the sine-cosine mechanism as popsize, wherein popsize is an integer greater than or equal to 20 and less than or equal to 100, that is, a population comprises popsize individuals; marking a maximum iteration of the population as M, expressing the dimension of each individual in the population by a one-row and dim-column data matrix, which is called a dimension matrix, formed by dim dimension values; setting a lower boundary matrix as lb, and setting an upper boundary matrix as ub, wherein lb=[lb₁, lb₂, lb₃, lb₄, lb₅], ub=[ub₁, ub₂, ub₃, ub₄, ub₅], ubⱼ represents a j^{th} element in the upper boundary matrix, lbⱼ represents a j^{th} element in the lower boundary matrix, and j=1, 2, 3, 4, 5; setting popsize=30, dim=5, M=2000, lb=[0, 0, 0, 0, 1] and ub=[1, e⁻⁶, 0.5 , 100 , 2], taking ubⱼ as an upper limit of a j^{th} dimension value of each individual in the population (dimension value of the individual in the first row and j^{th} column), and taking lbⱼ as a lower limit of the j^{th} dimension value of each individual in the population;

S3.2, defining two populations which are marked as a first population Q and a second population I respectively, and initializing the dimension of each individual in the first population Q and each individual in the second population I according to formula (3) and formula (4) respectively:

Q_{i,j}=lbⱼ+rand*(ubⱼ−lbⱼ) (3)

I_{i,j}=lbⱼ+rand*(ubⱼ−lbⱼ) (4)

Wherein, Q_{i,j} represents a j^{th} dimension value of an i^{th} individual in the first population [symbol] , I_{i,j} represents a j^{th} dimension value of an i^{th} individual in the second population I, i=1, 2, . . . , 30, rand represents a random number, which is greater than or equal to 0 and less than or equal to 1, generated by a random function, and rand is regenerated by the random function before each calculation according to formula (3) and formula (4);

S3.3, enabling the five dimension values of each individual in the first population Q and each individual in the second population I to correspond to the five parameters Iₚₕ, I_{sd}, R_{S}, Rₛₕ and n in formula (2) sequentially from left to right, substituting the five dimensional values of each individual in the first population [symbol] into formula (2) as values of the five parameters Iₚₕ, I_{sd}, R_{S}, Rₛₕ and n for calculation, and taking an error function value obtained by calculation as an error function value corresponding to each individual in the first population [symbol] , wherein the error function value corresponding to each individual is a fitness value of each individual; taking a minimum fitness value as a minimum fitness value of the first population [symbol] , marking the minimum fitness value of the first population [symbol] as fitness, and marking the individual corresponding to the minimum fitness value as position;

S3.4, defining two populations which are referred to as a first population Pop and a second population oldP respectively, initializing the first population and the second population, referring to the initialized first population as a 0-generation first population Pop₀, and referring to the initialized second population as a 0-generation second population oldP₀, wherein during initialization, the first population [symbol] is taken as the 0-generation first population Pop₀, the second population I is taken as the 0-generation second population oldP₀, a minimum fitness value of the 0-generation first population Pop₀ is marked as best_f₀, best_f₀=fitness, an individual, corresponding to the minimum fitness value, in the 0-generation first population Pop₀ is marked as best_p₀, best_p₀=position, the minimum fitness value of the 0-generation first population Pop₀ is taken as a 0-generation global optimal finesse value, and the individual, corresponding to the minimum fitness value, in the 0-generation first population Pop₀ is taken as a 0-generation global optimal individual;

S3.5, setting an iteration variable t, initializing t, and setting t=1;

S3.6, performing a t^{th} iteration on the first population to obtain a t^{th}-generation first population Popₜ after the t^{th} iteration, which specifically comprises:

S3.6.1, performing a selection-I operation, which specifically comprises: randomly generating two random numbers a and b, between 0 and 1, by a random function; comparing a and b; when a is greater than b, obtaining a t^{th}-generation second population oldP according to formula (5); or, when a is less than b, obtaining the t^{th}-generation second population oldP according to formula (6):

oldPₜ=permuting(Popₜ₋₁) (5)

oldPₜ=permuting(oldPₜ₋₁) (6)

Wherein, permuting(Popₜ₋₁) in formula (5) represents random resorting of all individuals in a (t−1)^{th}-generation first population Popₜ₋₁ after the individuals are disordered randomly, and permuting(oldPₜ₋₁) in formula (6) represents random resorting of all individuals in a (t−1)^{th}-generation second population oldPₜ₋₁ after the individuals are disordered randomly;

S3.6.2, performing a mutation operation through the sine-cosine mechanism to obtain a t^{th}-generation mutated population Mₜ, which specifically comprises:

Randomly disordering all the individuals in the (t−1)^{th}-generation first population Popₜ₋₁ three times, and then randomly resorting the individuals to obtain three new populations which are marked as Pop1ₜ₋₁, Pop2ₜ₋₁ and Pop3ₜ₋₁ respectively; constructing an error population Eₜ₋₁ comprising 30 individuals by taking a difference, obtained by subtracting the dimension of an i^{th} individual in Pop3ₜ₋₁ from the dimension of an i^{th} individual in Pop2ₜ₋₁, as the dimension of i^{th} individual in the error population Eₜ₋₁;

Constructing a scaling population Oₜ₋₁ comprising 30 individuals by taking data obtained by multiplying a difference, obtained by subtracting the dimension of an i^{th} individual in the (t−1)^{th}-generation first population Popₜ₋₁ from the dimension of an i^{th} individual in the t^{th}-generation second population oldPₜ, by a random number between 0 and 1 and then by a constant c varying with the iteration as the dimension of an i^{th} individual in the scaling population Oₜ₋₁, wherein c=1−t*((−1)/M);

Generating a random number l between 0 and 1 by a random function; if <0.5, setting a sine population Sₜ₋₁ comprising 30 individuals, taking data obtained by multiplying the dimension of the i^{th} individual in the scaling population Oₜ₋₁ by the sine of a random angle between 0 and 2π as the dimension of an i^{th} individual in the sine population Sₜ₋₁, updating the dimension of the i^{th} individual in the sine population Sₜ₋₁ to a sum of the dimension of the i^{th} individual in the sine population Sₜ₋₁ and the dimension of the i^{th} individual in the population Pop1ₜ₋₁, and taking the updated sine population Sₜ₋₁ as the t^{th}-generation mutated population Mₜ; or

If l≥0.5, setting a cosine population Cₜ₋₁ comprising 30 individuals, taking data obtained by multiplying the dimension of the i^{th} individual in the scaling population Oₜ₋₁ by the cosine of a random angle between 0 and 2π as the dimension of an i^{th} individual in the cosine population Cₜ₋₁, updating the dimension of the i^{th} individual in the cosine population Cₜ₋₁ to a sum of the dimension of the i^{th} individual in the cosine population Cₜ₋₁ and the dimension of the i^{th} individual in the population Pop1ₜ₋₁, and taking the updated cosine population Cₜ₋₁ as the t^{th}-generation mutated population Mₜ;

S3.6.3, performing boundary processing on the t^{th}-generation mutated population Mₜ to obtain a boundary population BCMₜ, which specifically comprises: determining whether the five dimension values of each individual in the t^{th}-generation mutated population Mₜ are between a lower limit and an upper limit of the individual, and updating the t^{th}-generation mutated population Mₜ based on a determination result, wherein a specific update rule is as follows: if one dimension value of the individual is less than the lower limit of the individual, this dimension of the individual is modified into the lower limit of the individual; if one dimension of the individual is greater than the upper limit of the individual, this dimension of the individual is modified into the upper limit of the individual; otherwise, this dimension of the individual remains unchanged; the updated t^{th}-generation mutated population Mₜ is the boundary population BCMₜ;

S3.6.4, performing a crossover operation on the boundary population BCMₜ to obtain a crossover population Vₜ, which specifically comprises: randomly generating a 30-row 5-column matrix mapₜ only comprising 0 or 1; when an element in the i^{th} row and j^{th} column in the matrix mapₜ is 1, updating a j^{th} dimension value of an i^{th} individual in the boundary population BCMₜ to the j^{th} dimension value of the i^{th} individual in the (t−1)^{th}-generation first population Popₜ₋₁; or, when the element in the i^{th} row and j^{th} column in the matrix mapₜ is 0, keeping the j^{th} dimension of the i^{th} individual in the boundary population BCMₜ unchanged; and taking the updated boundary population BCMₜ as the crossover population Vₜ;

S3.6.5, performing a selection-II operation on the crossover population Vₜ to obtain the t^{th}-generation first population Popₜ, which specifically comprises: taking the five dimension values of each individual in the crossover population Vₜ and each individual in the (t−1)^{th}-generation first population Popₜ₋₁ as values of the five parameters Iₚₕ, I_{sd}, R_{S}, Rₛₕ and n, then substituting the values of the five parameters Iₚₕ, I_{sd}, R_{S}, Rₛₕ and n to formula (2) to obtain a fitness value of each individual in the crossover population Vₜ and each individual in the (t−1)^{th}-generation first population Popₜ₋₁ by calculation, comparing the fitness value of the i^{th} individual in the crossover population Vₜ with the fitness value of the i^{th} individual in the (t−1)^{th}-generation first population Popₜ₋₁, and taking the individual with the smaller fitness value of the i^{th} individual in the crossover population Vₜ and the i^{th} individual in the (t−1)^{th}-generation first population Popₜ₋₁ as the i^{th} individual in the t^{th}-generation first population Popₜ, so that the t^{th}-generation first population Pope is obtained;

S3.7, comparing the fitness values of all individuals in the t^{th}-generation first population Popₜ to obtain a minimum fitness value, taking the minimum fitness value as the minimum fitness value best_fₜ of the t^{th}-generation first population Popₜ, and marking the individual corresponding to the minimum fitness value best_fₜ as the t^{th}-generation optimal individual; comparing the minimum fitness value best_fₜ of the t^{th}-generation first population Popₜ with a (t−1)^{th}-generation global optimal fitness value; if the minimum fitness value best_fₜ of the t^{th}-generation first population Popₜ is less than the (t−1)^{th}-generation global optimal fitness value, taking the minimum fitness value best_fₜ of the t^{th}-generation first population Popₜ as a t^{th}-generation global optimal fitness value; otherwise, taking the (t−1)^{th}-generation global optimal fitness value as the t^{th}-generation global optimal fitness value; then, taking an individual corresponding to the t^{th}-generation global optimal fitness value as a t^{th}-generation global optimal individual;

S3.8, determining whether a current value of t is equal to M; if the current value of t is not equal to M, updating the value of t to a sum of the current value of t and 1, and then returning to S3.6.1 to perform the next iteration; or, if the current value of t is equal to M, ending the iteration process, and outputting the five dimension values of an M^{th}-generation global optimal individual as the five identified parameters Iₚₕ, I_{sd}, R_{S}, Rₛₕ and n of the single-diode photovoltaic cell. Compared with traditional methods for identifying parameters of single-diode photovoltaic cells, the method of the invention replaces the mutation operation of the backtracking search algorithm with the sine-cosine mechanism, so that few restrictions are set, various properties of the objective function, such as whether the objective function is differentiable or the concavity and convexity of the objective function, do not need to be considered, the method is simple and easy to operate, and a larger amount of calculation is not needed; and the accuracy of parameter identification results is higher, and the reliability is better.

Compared with the prior art, the invention has the following advantages: an actual output voltage and an actual output current of a single-diode photovoltaic cell are measured under a given temperature and a given light intensity; then, an ideal model of the single-diode photovoltaic cell is constructed, to-be-identified parameters are determined, and an objective function is established; and finally, the to-be-identified parameters are identified through a backtracking search algorithm based on a sine-cosine mechanism to obtain to-be-identified parameter data of the single-diode photovoltaic cell, so that the parameter identification of the single-diode photovoltaic cell is completed. The method of the invention adopts the backtracking search algorithm for parameter identification and replaces the mutation operation of the backtracking search algorithm with the sine-cosine mechanism during the identification process to prevent part of optimal search spaces from being neglected, thus being able to identify the parameters of single-diode photovoltaic cells more reliably and accurately.

### BRIEF DESCRIPTION OF THE DRAWINGS

FIG. 1 illustrates an ideal model of a single-diode photovoltaic cell adopted in a method for identifying parameters of single-diode photovoltaic cells according to the invention.

### DESCRIPTION OF THE EMBODIMENTS

The invention will be described in further detail below in conjunction with the accompanying drawing and embodiments.

Embodiment: a method for identifying parameters of single-diode photovoltaic cells comprises the following steps:

S1, measuring an actual output voltage and an actual output current of a single-diode photovoltaic cell under a given temperature and a given light intensity;

S2, constructing an ideal model of the single-diode photovoltaic cell, determining to-be-identified parameters, and establishing an objective function; and

S3, identifying the to-be-identified parameters, determined in S2, through a backtracking search algorithm based on a sine-cosine mechanism to obtain to-be-identified parameter data of the single-diode photovoltaic cell, so that identification of the parameters of the single-diode photovoltaic cell is completed.

In this embodiment, the given temperature is within 0-100° C., and the given light intensity is within 0-1000W/m².

In this embodiment, a specific process of constructing an ideal model of the single-diode photovoltaic cell, determining to-be-identified parameters and establishing an objective function in S2 comprises:

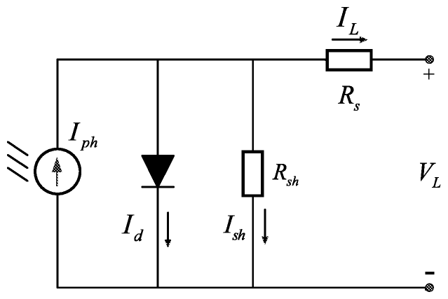

S2.1, constructing the ideal model of the single-diode photovoltaic cell, wherein the ideal model of the single-diode photovoltaic cell is composed of a series resistor R1, a shunt resistor R2, a diode D1 and an optical-drive current source V1; a positive pole of the optical-drive current source V1, an anode of the diode D1 and one terminal of the series resistor R1 are connected to one terminal of the shunt resistor R2; a negative pole of the optical-drive current source V1 and a cathode of the diode D1 are connected to the other terminal of the shunt resistor R2, and a connecting terminal is a negative pole of the single-diode photovoltaic cell; the other terminal of the series resistor R1 is a positive pole of the single-diode photovoltaic cell, as shown in FIG. 1;

S2.2, marking a resistance of the series resistor R1 as Rₛ, marking a resistance of the shunt resistor R2 as Rₛₕ, marking a forward current across the diode D1 as I_{d}, marking an output current of the optical-drive current source V1 as Iₚₕ, and expressing a characteristic equation of an output current and an output voltage of the single-diode photovoltaic cell by formula (1):

$${I}_{L} = {I}_{p h} - {I}_{d} - {I}_{s h} = {I}_{p h} - {I}_{sd} [ exp ( \frac{q ( {V}_{A} + {R}_{S} {I}_{A} )}{nkT} ) - 1 ] - \frac{{V}_{L} + {R}_{S} {I}_{L}}{{R}_{s h}} \qquad ( 1 )$$

Wherein, I_{L} represents a theoretical output current of the single-diode photovoltaic cell; V_{L} represents a theoretical output voltage of the single-diode photovoltaic cell; I_{sd} represents a reverse saturation current of the diode D1; q represents an electron charge (1.608×10⁻¹⁹C); k represents a Boltzmann constant (1.1.280×10⁻²³ J/K); T represents an absolute temperature of the single-diode photovoltaic cell; n represents a quality factor of the diode D1; exp represents an exponential function with e as a base; and five to-be-identified parameters of the single-diode photovoltaic cell are the output current Iₚₕ of the optical-drive current source V1, the reverse saturation current I_{sd} of the diode D1, the quality factor n of the diode D1, the resistance R_{S} of the series resistor R1 and the resistance Rₛₕ of the shunt resistor R2, respectively;

S2.3, establishing the objective function of the single-diode photovoltaic cell, and expressing the objective function by formula (2):

$$f ( {V}_{A} , {I}_{A} , X ) = {I}_{p h} - {I}_{sd} [ exp ( \frac{q ( {V}_{A} + {R}_{S} {I}_{A} )}{nkT} ) - 1 ] - \frac{{V}_{A} + {R}_{S} {I}_{A}}{{R}_{s h}} - {I}_{A} \qquad ( 2 )$$

Wherein, I_{A} represents the actual output current of the single-diode photovoltaic cell; V_{A} represents the actual output voltage of the single-diode photovoltaic cell; q represents the electron charge (1.608×10⁻¹⁹C); k represents the Boltzmann constant (1.1.280×10⁻²³ J/K); T represents the absolute temperature of the single-diode photovoltaic cell; ranges of the five to-be-identified parameters are 0≤/Iₚₕ≤1 A, 0≤I_{sd}≤1 μA, 0≤R_{S}<0.5 Ω, 0≤Rₛₕ≤100 Ω and 1≤n≤2, respectively; ƒ(V_{A}, I_{A}, X) represents an error function of the theoretical output current and the actual output current of the single-diode photovoltaic cell; X represents a set of the to-be-identified parameters of the single-diode photovoltaic cell, namely X=[Iₚₕ, I_{sd}, R_{S}, Rₛₕ, n];

In this embodiment, a specific process of identifying the to-be-identified parameters, determined in S2, through a backtracking search algorithm based on a sine-cosine mechanism to obtain to-be-identified parameter data of the single-diode photovoltaic cell in S3 comprises:

S3.1, marking a population size of the backtracking search algorithm based on the sine-cosine mechanism as popsize, wherein popsize is an integer greater than or equal to and less than or equal to 100, that is, a population comprises popsize individuals; marking a maximum iteration of the population as M, expressing the dimension of each individual in the population by a one-row and dim-column data matrix, which is called a dimension matrix, formed by dim dimension values; setting a lower boundary matrix as lb, and setting an upper boundary matrix as ub, wherein lb=[lb₁, lb₂, lb₃, lb₄, lb₅], ub=[ub₁, ub₂, ub₃, ub₄, ub₅], represents a j^{th} element in the upper boundary matrix, lbⱼ represents a j^{th} element in the lower boundary matrix, and j=1, 2, 3, 4, 5; setting popsize=30, dim=5, M=2000, lb=[0, 0, 0, 0, 1] and ub=[1, e⁻⁶, 0.5, 100, 2], taking ubⱼ as an upper limit of a j^{th} dimension value of each individual in the population (dimension value of the individual in the first row and j^{th} column), and taking lbⱼ as a lower limit of the j^{th} dimension value of each individual in the population;

S3.2, defining two populations which are marked as a first population [symbol] and a second population I respectively, and initializing the dimension of each individual in the first population [symbol] and each individual in the second population I according to formula (3) and formula (4) respectively:

Q_{i,j}=lbⱼ+rand*(ubⱼ−lb₁) tm (3)

I_{i,j}=lbⱼ+rand*(ubⱼ−lbⱼ) (4)

Wherein, Q_{i,j} represents a j^{th} dimension value of an i^{th} individual in the first population [symbol] , I_{i,j} represents a j^{th} dimension value of an i^{th} individual in the second population I, i=1, 2, . . . , 30, rand represents a random number, which is greater than or equal to 0 and less than or equal to 1, generated by a random function, and rand is regenerated by the random function before each calculation according to formula (3) and formula (4);

S3.3, enabling the five dimension values of each individual in the first population Q and each individual in the second population I to correspond to the five parameters Iₚₕ, I_{sd}, R_{S}, Rₛₕ and n in formula (2) sequentially from left to right, substituting the five dimensional values of each individual in the first population [symbol] into formula (2) as values of the five parameters Iₚₕ, I_{sd}, R_{S}, Rₛₕ and n for calculation, and taking an error function value obtained by calculation as an error function value corresponding to each individual in the first population [symbol] , wherein the error function value corresponding to each individual is a fitness value of each individual; taking a minimum fitness value as a minimum fitness value of the first population [symbol] , marking the minimum fitness value of the first population [symbol] as fitness, and marking the individual corresponding to the minimum fitness value as position;

S3.4, defining two populations which are referred to as a first population Pop and a second population oldP respectively, initializing the first population and the second population, referring to the initialized first population as a 0-generation first population Pop₀, and referring to the initialized second population as a 0-generation second population oldP₀, wherein during initialization, the first population [symbol] is taken as the 0-generation first population Pop₀, the second population I is taken as the 0-generation second population oldP₀, a minimum fitness value of the 0-generation first population Pop₀ is marked as best_f₀, best_f₀=fitness, an individual, corresponding to the minimum fitness value, in the 0-generation first population Pop₀ is marked as best_p₀, best_p₀=position, the minimum fitness value of the 0-generation first population Pop₀ is taken as a 0-generation global optimal finesse value, and the individual, corresponding to the minimum fitness value, in the 0-generation first population Pop₀ is taken as a 0-generation global optimal individual;

S3.5, setting an iteration variable t, initializing t, and setting t=1;

S3.6, performing a t^{th} iteration on the first population to obtain a t^{th}-generation first population Popₜ after the t^{th} iteration, which specifically comprises:

S3.6.1, performing a selection-I operation, which specifically comprises: randomly generating two random numbers a and b, between 0 and 1, by a random function; comparing a and b; when a is greater than b, obtaining a t^{th}-generation second population oldP according to formula (5); or, when a is less than b, obtaining the t^{th}-generation second population oldP according to formula (6):

oldPₜ=permuting(Popₜ₋₁) (5)

oldPₜ=permuting(oldPₜ₋₁) (6)

Wherein, permuting (Popₜ₋₁) in formula (5) represents random resorting of all individuals in a (t−1)^{th}-generation first population Popₜ₋₁ after the individuals are disordered randomly, and permuting (oldPₜ₋₁) in formula (6) represents random resorting of all individuals in a (t−1)^{th}-generation second population oldPₜ₋₁ after the individuals are disordered randomly;

S3.6.2, performing a mutation operation through the sine-cosine mechanism to obtain a t^{th}-generation mutated population Mₜ, which specifically comprises:

Randomly disordering all the individuals in the (t−1)^{th}-generation first population Popₜ₋₁ three times, and then randomly resorting the individuals to obtain three new populations which are marked as Pop1ₜ₋₁, Pop2ₜ₋₁ and Pop3ₜ₋₁ respectively; constructing an error population Eₜ₋₁ comprising 30 individuals by taking a difference, obtained by subtracting the dimension of an i^{th} individual in Pop3ₜ₋₁ from the dimension of an i^{th} individual in Pop2ₜ₋₁, as the dimension of i^{th} individual in the error population Eₜ₋₁;

Constructing a scaling population Oₜ₋₁ comprising 30 individuals by taking data obtained by multiplying a difference, obtained by subtracting the dimension of an i^{th} individual in the (t−1)^{th}-generation first population Popₜ₋₁ from the dimension of an i^{th} individual in the t^{th}-generation second population oldPₜ, by a random number between 0 and 1 and then by a constant c varying with the iteration as the dimension of an i^{th} individual in the scaling population Oₜ₋₁, wherein c=1−t*((−1)/M);

Generating a random number l between 0 and 1 by a random function; if <0.5, setting a sine population Sₜ₋₁ comprising 30 individuals, taking data obtained by multiplying the dimension of the i^{th} individual in the scaling population Oₜ₋₁ by the sine of a random angle between 0 and 2π (π represents the circular constant and is 3.1415926), the dimension of an i^{th} individual in the sine population Sₜ₋₁, updating the dimension of the i^{th} individual in the sine population Sₜ₋₁ to a sum of the dimension of the i^{th} individual in the sine population Sₜ₋₁ and the dimension of the i^{th} individual in the population Pop1ₜ₋₁, and taking the updated sine population Sₜ₋₁ as the t^{th}-generation mutated population Mₜ; or

If l≥0.5, setting a cosine population Cₜ₋₁ comprising 30 individuals, taking data obtained by multiplying the dimension of the i^{th} individual in the scaling population Oₜ₋₁ by the cosine of a random angle between 0 and 2π as the dimension of an i^{th} individual in the cosine population Cₜ₋₁, updating the dimension of the i^{th} individual in the cosine population Cₜ₋₁ to a sum of the dimension of the i^{th} individual in the cosine population Cₜ₋₁ and the dimension of the i^{th} individual in the population Pop1ₜ₋₁, and taking the updated cosine population Cₜ₋₁ as the t^{th}-generation mutated population Mₜ;

S3.6.3, performing boundary processing on the t^{th}-generation mutated population Mₜ to obtain a boundary population BCMₜ, which specifically comprises: determining whether the five dimension values of each individual in the t^{th}-generation mutated population Mₜ are between a lower limit and an upper limit of the individual, and updating the t^{th}-generation mutated population Mₜ based on a determination result, wherein a specific update rule is as follows: if one dimension value of the individual is less than the lower limit of the individual, this dimension of the individual is modified into the lower limit of the individual; if one dimension of the individual is greater than the upper limit of the individual, this dimension of the individual is modified into the upper limit of the individual; otherwise, this dimension of the individual remains unchanged; the updated t^{th}-generation mutated population Mₜ is the boundary population BCMₜ;

S3.6.4, performing a crossover operation on the boundary population BCMₜ to obtain a crossover population Vₜ, which specifically comprises: randomly generating a 30-row 5-column matrix mapₜ only comprising 0 or 1; when an element in the i^{th} row and j^{th} column in the matrix mapₜ is 1, updating a j^{th} dimension value of an i^{th} individual in the boundary population BCMₜ to the j^{th} dimension value of the i^{th} individual in the (t−1)^{th}-generation first population Popₜ₋₁; or, when the element in the i^{th} row and j^{th} column in the matrix mapₜ is 0, keeping the j^{th} dimension of the i^{th} individual in the boundary population BCMₜ unchanged; and taking the updated boundary population BCMₜ as the crossover population Vₜ;

S3.6.5, performing a selection-II operation on the crossover population Vₜ to obtain the t^{th}-generation first population Popₜ, which specifically comprises: taking the five dimension values of each individual in the crossover population Vₜ and each individual in the (t−1)th-generation first population Popₜ₋₁ as values of the five parameters Iₚₕ, I_{sd}, R_{S}, Rₛₕ and n, then substituting the values of the five parameters Iₚₕ, I_{sd}, R_{S}, Rₛₕ and n to formula (2) to obtain a fitness value of each individual in the crossover population Vₜ and each individual in the (t−1)th-generation first population Popₜ₋₁ by calculation, comparing the fitness value of the i^{th} individual in the crossover population Vₜ with the fitness value of the i^{th} individual in the (t−1)th-generation first population Popₜ₋₁, and taking the individual with the smaller fitness value of the i^{th} individual in the crossover population Vₜ and the i^{th} individual in the (t−1)^{th}-generation first population Popₜ₋₁ as the i^{th} individual in the t^{th}-generation first population Popₜ, so that the t^{th}-generation first population Popₜ is obtained;

S3.7, comparing the fitness values of all individuals in the t^{th}-generation first population Popₜ to obtain a minimum fitness value, taking the minimum fitness value as the minimum fitness value best_fₜ of the t^{th}-generation first population Popₜ, and marking the individual corresponding to the minimum fitness value best_fₜ as the t^{th}-generation optimal individual; comparing the minimum fitness value best_fₜ of the t^{th}-generation first population Popₜ with a (t−1)^{th}-generation global optimal fitness value; if the minimum fitness value best_fₜ of the t^{th}-generation first population Popₜ is less than the (t−1)^{th}-generation global optimal fitness value, taking the minimum fitness value best_fₜ of the t^{th}-generation first population Popₜ as a t^{th}-generation global optimal fitness value; otherwise, taking the (t−1)^{th}-generation global optimal fitness value as the t^{th}-generation global optimal fitness value; then, taking an individual corresponding to the t^{th}-generation global optimal fitness value as a t^{th}-generation global optimal individual;

S3.8, determining whether a current value of t is equal to M; if the current value of t is not equal to M updating the value of t to a sum of the current value of t and 1, and then returning to S3.6.1 to perform the next iteration; or, if the current value of t is equal to M, ending the iteration process, and outputting the five dimension values of an M^{th}-generation global optimal individual as the five identified parameters Iₚₕ, I_{sd}, R_{S}, Rₛₕ and n of the single-diode photovoltaic cell.

1. A method for identifying parameters of single-diode photovoltaic cells, comprising:
S1, measuring an actual output voltage and an actual output current of a single-diode photovoltaic cell under a given temperature and a given light intensity;
S2, constructing an ideal model of the single-diode photovoltaic cell, determining to-be-identified parameters, and establishing an objective function; and
S3, identifying the to-be-identified parameters, determined in the S2, through a backtracking search algorithm based on a sine-cosine mechanism to obtain to-be-identified parameter data of the single-diode photovoltaic cell, so that identification of the parameters of the single-diode photovoltaic cell is completed.

2. The method for identifying parameters of single-diode photovoltaic cells according to claim 1, wherein a specific process of constructing the ideal model of the single-diode photovoltaic cell, determining the to-be-identified parameters and establishing the objective function in the S2 comprises:
S2.1, constructing the ideal model of the single-diode photovoltaic cell, wherein the ideal model of the single-diode photovoltaic cell is composed of a series resistor, a shunt resistor, a diode and an optical-drive current source, wherein a positive pole of the optical-drive current source, an anode of the diode and one terminal of the series resistor are connected to one terminal of the shunt resistor, wherein a negative pole of the optical-drive current source and a cathode of the diode are connected to the other terminal of the shunt resistor, and a connecting terminal is a negative pole of the single-diode photovoltaic cell, wherein the other terminal of the series resistor is a positive pole of the single-diode photovoltaic cell;
S2.2, marking a resistance of the series resistor as Rₛ, marking a resistance of the shunt resistor as Rₛₕ, marking a forward current across the diode as I_{d}, marking an output current of the optical-drive current source as Iₚₕ, and expressing a characteristic equation of an output current and an output voltage of the single-diode photovoltaic cell by formula (1):
$${I}_{L} = {I}_{p h} - {I}_{d} - {I}_{s h} = {I}_{p h} - {I}_{sd} [ exp ( \frac{q ( {V}_{A} + {R}_{S} {I}_{A} )}{nkT} ) - 1 ] - \frac{{V}_{L} + {R}_{S} {I}_{L}}{{R}_{s h}} \qquad ( 1 )$$
wherein I_{L} is a theoretical output current of the single-diode photovoltaic cell, V_{L} is a theoretical output voltage of the single-diode photovoltaic cell, I_{sd} is a reverse saturation current of the diode, q is an electron charge (1.608×10⁻¹⁹ Coulomb (C)), k is a Boltzmann constant (1.1.280×10⁻²³ Joule (J)/Kelvin (K)), T is an absolute temperature of the single-diode photovoltaic cell, n is a quality factor of the diode, exp is an exponential function with e as a base, and five to-be-identified parameters of the single-diode photovoltaic cell are the output current Iₚₕ of the optical-drive current source, the reverse saturation current I_{sd} of the diode, the quality factor n of the diode, the resistance R_{S} of the series resistor and the resistance Rₛₕ of the shunt resistor, respectively;
S2.3, establishing the objective function of the single-diode photovoltaic cell, and expressing the objective function by formula (2):
$$f ( {V}_{A} , {I}_{A} , X ) = {I}_{p h} - {I}_{sd} [ exp ( \frac{q ( {V}_{A} + {R}_{S} {I}_{A} )}{nkT} ) - 1 ] - \frac{{V}_{A} + {R}_{S} {I}_{A}}{{R}_{s h}} - {I}_{A} \qquad ( 2 )$$
wherein I_{A} is the actual output current of the single-diode photovoltaic cell, V_{A} is the actual output voltage of the single-diode photovoltaic cell, q is the electron charge (1.608×10⁻¹⁹C), k is the Boltzmann constant (1.1.280×10⁻²³ J/K), T is the absolute temperature of the single-diode photovoltaic cell, ranges of the five to-be-identified parameters are a first range of 0 to 1 Ampere (A) for the output current Iₚₕ, a second range of 0 to 1 micro-A (μA) for the reverse saturation current I_{sd}, a third range of 0 to 1.5 Ohm (Ω) for the resistance R_{S} of the series resistor, a fourth range of 0 to 100 Ω for the resistance Rₛₕ of the shunt resistor, and a fifth range of 0 to 2 for the quality factor of the diode n, respectively, ƒ(V_{A}, I_{A}, X) is an error function of the theoretical output current and the actual output current of the single-diode photovoltaic cell, X is a set of the to-be-identified parameters of the single-diode photovoltaic cell.

3. The method for identifying parameters of single-diode photovoltaic cells according to claim 1, wherein a specific process of identifying the to-be-identified parameters, determined in the S2, through the backtracking search algorithm based on the sine-cosine mechanism to obtain the to-be-identified parameter data of the single-diode photovoltaic cell in the S3 comprises:
S3.1, marking a population size of the backtracking search algorithm based on the sine-cosine mechanism as popsize, wherein the popsize is an integer greater than or equal to 20 and less than or equal to 100, that is, a population comprises popsize individuals; marking a maximum iteration of the population as M, expressing the dimension of each individual in the population by a one-row and dim-column data matrix which is called a dimension matrix and is formed by dim dimension values; setting a lower boundary matrix as lb, and setting an upper boundary matrix as ub, wherein the lower boundary matrixlb is a set of lb₁, lb₂, lb₃, lb₄ and lb₅, the upper boundary matrix ub is a set of ub₁, ub₂, ub₃, ub₄ and ub₅, an element ubⱼ is a j^{th} element in the upper boundary matrix, an element lbⱼ is a j^{th} element in the lower boundary matrix, wherein the j is a set of 1, 2, 3, 4 and 5; setting the sine-cosine mechanism popsize to be 30; setting the column dim to be 5; setting the maximum iteration of the population M to be 2000; setting the lower boundary matrix lb to be a set of 0, 0, 0, 0, 1; setting upper boundary matrix ub to be a set of 1, e⁻⁶, 0.5, 100, 2; taking the element ubⱼ as an upper limit of a j^{th} dimension value of each individual in the population (dimension value of the individual in the first row and j^{th} column), and taking the element lbⱼ as a lower limit of the j^{th} dimension value of each individual in the population;
S3.2, defining two populations which are marked as a first population [symbol] and a second population I respectively, and initializing the dimension of each individual in the first population [symbol] and each individual in the second population I according to formula (3) and formula (4) respectively:
Q_{i,j}=lbⱼ+rand*(ubⱼ−lbⱼ) (3)
I_{i,j}=lbⱼ+rand*(ubⱼ−lbⱼ) (4)
wherein, Q_{i,j} is a j^{th} dimension value of an i^{th} individual in the first population [symbol] , I_{i,j} is a j^{th} dimension value of an i^{th} individual in the second population I, wherein the i is a set of integers of 1 to 30 rand is a random number which is greater than or equal to 0 and less than or equal to 1 and is generated by a random function, and the rand is regenerated by the random function before each calculation according to formula (3) and formula (4);
S3.3, enabling the five dimension values of each individual in the first population Q and each individual in the second population I to correspond to the five parameters Iₚₕ, I_{sd}, R_{S}, Rₛₕ and n in formula (2) sequentially from left to right, substituting the five dimensional values of each individual in the first population [symbol] into formula (2) as values of the five parameters Iₚₕ, I_{sd}, R_{S}, Rₛₕ and n for calculation, and taking an error function value obtained by calculation as an error function value corresponding to each individual in the first population [symbol] , wherein the error function value corresponding to each individual is a fitness value of each individual; taking a minimum fitness value as a minimum fitness value of the first population [symbol] , marking the minimum fitness value of the first population [symbol] as fitness, and marking the individual corresponding to the minimum fitness value as position;
S3.4, defining two populations which are referred to as a first population Pop and a second population oldP respectively, initializing the first population and the second population, referring to the initialized first population as a 0-generation first population Pop₀, and referring to the initialized second population as a 0-generation second population oldP₀, wherein during initialization, the first population [symbol] is taken as the 0-generation first population Pop₀, the second population I is taken as the 0-generation second population oldP₀, a minimum fitness value of the 0-generation first population Pop₀ is marked as best_f₀, setting the best_f₀ to be fitness, an individual, corresponding to the minimum fitness value, in the 0-generation first population Pop₀ is marked as best_p₀, setting the best_p₀ to be position, the minimum fitness value of the 0-generation first population Pop₀ is taken as a 0-generation global optimal finesse value, and the individual, corresponding to the minimum fitness value, in the 0-generation first population Pop₀ is taken as a 0-generation global optimal individual;
S3.5, setting an iteration variable t, initializing t, and setting the iteration variable iteration variable t to be 1;
S3.6, performing a t^{th} iteration on the first population to obtain a t^{th}-generation first population Popₜ after the t^{th} iteration, which specifically comprises:
S3.6.1, performing a selection-I operation, which specifically comprises: randomly generating two random numbers a and b, between 0 and 1, by a random function; comparing a and b; when a is greater than b, obtaining a t^{th}-generation second population oldP according to formula (5); or, when a is less than b, obtaining the t^{th}-generation second population oldP according to formula (6):
oldPₜ=permuting(Popₜ₋₁) (5)
oldPₜ=permuting(oldPₜ₋₁) (6)
wherein, permuting (Popₜ₋₁) in formula (5) is random resorting of all individuals in a (t−1)^{th}-generation first population Popₜ₋₁ after the individuals are disordered randomly, and permuting(oldPₜ₋₁) in formula (6) is random resorting of all individuals in a (t−1)^{th}-generation second population oldPₜ₋₁ after the individuals are disordered randomly;
S3.6.2, performing a mutation operation through the sine-cosine mechanism to obtain a t^{th}-generation mutated population Mₜ, comprising:
randomly disordering all the individuals in the (t−1)^{th}-generation first population Popₜ₋₁ three times, and then randomly resorting the individuals to obtain three new populations which are marked as Pop1ₜ₋₁, Pop2ₜ₋₁ and Pop3ₜ₋₁ respectively; constructing an error population Eₜ₋₁ comprising 30 individuals by taking a difference, obtained by subtracting the dimension of an i^{th} individual in Pop3ₜ₋₁ from the dimension of an i^{th} individual in Pop2ₜ₋₁, as the dimension of i^{th} individual in the error population Eₜ₋₁;
constructing a scaling population Oₜ₋₁ comprising 30 individuals by taking data obtained by multiplying a difference, obtained by subtracting the dimension of an i^{th} individual in the (t−1)^{th}-generation first population Popₜ₋₁ from the dimension of an i^{th} individual in the t^{th}-generation second population oldPₜ, by a random number between 0 and 1 and then by a constant c varying with the iteration as the dimension of an i^{th} individual in the scaling population Oₜ₋₁, wherein c=1−t*((−1)/M);
generating a random number 1 between 0 and 1 by a random function; if the random number l is less than 0.5, setting a sine population Sₜ₋₁ comprising 30 individuals, taking data obtained by multiplying the dimension of the i^{th} individual in the scaling population Oₜ₋₁ by the sine of a random angle between 0 and 2π as the dimension of an i^{th} individual in the sine population Sₜ₋₁, updating the dimension of the i^{th} individual in the sine population Sₜ₋₁ to a sum of the dimension of the i^{th} individual in the sine population Sₜ₋₁ and the dimension of the i^{th} individual in the population Pop1ₜ₋₁, and taking the updated sine population Sₜ₋₁ as the t^{th}-generation mutated population Mₜ; or
if the random number l is greater than or equal to 0.5, setting a cosine population Cₜ₋₁ comprising 30 individuals, taking data obtained by multiplying the dimension of the i^{th} individual in the scaling population Oₜ₋₁ by the cosine of a random angle between 0 and 2π as the dimension of an i^{th} individual in the cosine population Cₜ₋₁, updating the dimension of the i^{th} individual in the cosine population Cₜ₋₁ to a sum of the dimension of the i^{th} individual in the cosine population Cₜ₋₁ and the dimension of the i^{th} individual in the population Pop1ₜ₋₁, and taking the updated cosine population Cₜ₋₁ as the t^{th}-generation mutated population Mₜ;
S3.6.3, performing boundary processing on the t^{th}-generation mutated population Mₜ to obtain a boundary population BCMₜ, comprising: determining whether the five dimension values of each individual in the t^{th}-generation mutated population Mₜ are between a lower limit and an upper limit of the individual, and updating the t^{th}-generation mutated population Mₜ based on a determination result, wherein a specific update rule is as follows: if one dimension value of the individual is less than the lower limit of the individual, this dimension of the individual is modified into the lower limit of the individual; if one dimension of the individual is greater than the upper limit of the individual, this dimension of the individual is modified into the upper limit of the individual; otherwise, this dimension of the individual remains unchanged; the updated t^{th}-generation mutated population Mₜ is the boundary population BCMₜ;
S3.6.4, performing a crossover operation on the boundary population BCMₜ to obtain a crossover population Vₜ, comprising: randomly generating a 30-row 5-column matrix mapₜ only comprising 0 or 1; when an element in the i^{th} row and j^{th} column in the matrix mapₜ is 1, updating a j^{th} dimension value of an i^{th} individual in the boundary population BCMₜ to the j^{th} dimension value of the i^{th} individual in the (t−1)^{th}-generation first population Popₜ₋₁; or, when the element in the i^{th} row and j^{th} column in the matrix mapₜ is 0, keeping the j^{th} dimension of the i^{th} individual in the boundary population BCMₜ unchanged; and taking the updated boundary population BCMₜ as the crossover population Vₜ;
S3.6.5, performing a selection-II operation on the crossover population Vₜ to obtain the t^{th}-generation first population Popₜ, comprising: taking the five dimension values of each individual in the crossover population Vₜ and each individual in the (t−1)^{th}-generation first population Popₜ₋₁ as values of the five parameters Iₚₕ, I_{sd}, R_{S}, Rₛₕ and n, then substituting the values of the five parameters Iₚₕ, I_{sd}, R_{S}, Rₛₕ and n to formula (2) to obtain a fitness value of each individual in the crossover population Vₜ and each individual in the (t−1)^{th}-generation first population Popₜ₋₁ by calculation, comparing the fitness value of the i^{th} individual in the crossover population Vₜ with the fitness value of the i^{th} individual in the (t−1)^{th}-generation first population Popₜ₋₁, and taking the individual with the smaller fitness value of the i^{th} individual in the crossover population Vₜ and the i^{th} individual in the (t−1)^{th}-generation first population Popₜ₋₁ as the i^{th} individual in the t^{th}-generation first population Popₜ₋₁, so that the t^{th}-generation first population Popₜ₋₁ is obtained;
S3.7, comparing the fitness values of all individuals in the t^{th}-generation first population Popₜ₋₁ to obtain a minimum fitness value, taking the minimum fitness value as the minimum fitness value best_fₜ of the t^{th}-generation first population Popₜ₋₁, and marking the individual corresponding to the minimum fitness value best_fₜ as the t^{th}-generation optimal individual; comparing the minimum fitness value best_fₜ of the t^{th}-generation first population Popₜ₋₁ with a (t−1)^{th}-generation global optimal fitness value; if the minimum fitness value best_fₜ of the t^{th}-generation first population Popₜ₋₁ is less than the (t−1)^{th}-generation global optimal fitness value, taking the minimum fitness value best_fₜ of the t^{th}-generation first population Popₜ₋₁ as a t^{th}-generation global optimal fitness value; otherwise, taking the (t−1)^{th}-generation global optimal fitness value as the t^{th}-generation global optimal fitness value; then, taking an individual corresponding to the t^{th}-generation global optimal fitness value as a t^{th}-generation global optimal individual;
S3.8, determining whether a current value of t is equal to M; if the current value of t is not equal to M, updating the value of t to a sum of the current value of t and 1, and then returning to S3.6.1 to perform the next iteration; or, if the current value of t is equal to M, ending the iteration process, and outputting the five dimension values of an M^{th}-generation global optimal individual as the five identified parameters Iₚₕ, I_{sd}, R_{S}, Rₛₕ and n of the single-diode photovoltaic cell.
